(19) United States
(12) Patent Application Publication
(10) Pub. No.: US 2014/0302997 A1
(43) Pub. Date: Oct. 9, 2014

(54) Superconducting Power Cable

(71) Applicant: Makoto Takayasu, Lexington, MA (US)

(72) Inventor: Makoto Takayasu, Lexington, MA (US)

(21) Appl. No.: 14/243,008

(22) Filed: Apr. 2, 2014

Related U.S. Application Data
(60) Provisional application No. 61/853,460, filed on Apr. 6, 2013.

(51) Int. Cl. H01B 12/04; H01B 12/10

(52) U.S. Cl. CPC H01B 12/04; H01B 12/10
USPC 505/231; 505/230; 174/102 R; 174/15.5

(57) ABSTRACT

A superconducting cable for power lead and transmission applications is disclosed. The high performance power cable comprises two type of different superconducting cable structures arranged co-axially, and the magnetic fields of their transport currents mutually enhance their performances. A further object is a power distribution cable that minimizes the cryogenic losses by a design of the compact cable cross-sections.

This application claims priority to U.S. Provisional Application Ser. No. 61/853,460, filed Apr. 6, 2013, the disclosure of which is incorporated herein by reference in its entirety.

### FIELD

This disclosure relates to superconductor cables, and more particularly, to a superconductor power cable comprising two types of differently structured superconducting cables, formed co-axially.

### BACKGROUND

Over the last decade, significant efforts have been devoted to the development of high temperature superconductor (HTS) wires using the first-generation BSCCO-2223 and BSCCO-2212, and the second-generation YBCO for various electrotechnical device applications, such as transformers, fault current limiters, energy storage systems, magnets and power transmission cables. Most HTS tape devices have been using configurations employing a single tape or only a few tapes in parallel. Few cabling methods for HTS tapes have been developed.

Conventional power transmission cables carrying about 1-3 kA have already been demonstrated by helically winding the tapes on a cylindrical former. Those windings are typically enclosed in a tube cryostat. However, this cabling approach is not adequate for high current and high current density cables.

The current capacity of superconducting conductors can be increased with a parallel arrangement of the wires. However, flux couplings created in the loop circuits among the parallel superconducting wires generate significant heat losses, caused by resistive and magnetic hysteresis losses in the superconducting wires. The magnetic flux coupling can be reduced by the well-known transposition technique of twisting wires. If the wires have circular cross sections, such as is the case with NbTi and Nb₃Sn superconductors, the twisting transposition can be easily implemented. However, the present flat shapes of both 1G and 2G HTS tapes are not well suited for transposition of bundled multiple tapes. The twisting transposition technology has not been attempted for flat HTS superconducting tape conductors, although round strands of BSCCO-2212 HTS superconductor have been developed, and high current cables using a conventional Rutherford-type cabling method have been successfully manufactured.

A successful development of a transposed high current cable for flat HTS tape superconductors is the Roebel assembled coated conductors. The cabling method requires cutting a flat HTS tape in a specially designed zigzag pattern and assembling the flat tapes to form a transposed cable. The Roebel cabling technology is a good method to reduce AC losses: however, it may be difficult to develop a large conductor due to the fabrication method used for this cable. So far cables of about 2.6 kA have been fabricated.

Recently, a novel cabling method of winding flat HTS tapes on a surface of a relatively small round former with a very tight winding pitch, Conductor-on-Round-Core (CORC) has been developed. Since 2G coated HTS tapes have superb mechanical behavior in response to strains, the 4 mm wide 2G HTS tapes were wound on a 3.2 mm diameter rod with twist pitches of 9-40 mm without significant degradation. This cabling method provides a very flexible conductor; however, it results in low overall current density, and may result in poor utilization of the HTS tapes. This cabling method has been used to demonstrate a flexible cable of 2.8 kA which was wound using 24 GBCO-coated HTS tapes of 4 mm width with eight layers on a 5.5 mm diameter former.

FIG. 13 summarizes the four HTS tape-cabling methods described above. Developments of these HTS tape cabling methods and their characterizations have been carried out over the last several years, except the power transmission line cables. All those methods are not completely mature yet.

A simpler and more scalable cabling method of a twisted, stacked-tape geometry applicable to high current, high field magnet applications, has been disclosed, in which stacked flat tapes are twisted along the axis of the stack, as shown in FIGS. 11(a)-(b). The twisted, stacked-tape cabling method allows developments of high current, compact conductors for various applications such as power transmission cables and high field magnets.

However, none of these techniques is completely satisfactory. Therefore, an improved superconducting power cable would be beneficial.

### SUMMARY

The superconducting power cable comprises an inner cable and an outer cable, which may be two different types of cables, structured co-axially. The double co-axial cable produces longitudinal fields to the cable tapes (wires) mutually. That is, the current of the outer cable wound cylindrically along the inner cable wires generates an axial field to the inner cable, and the current of the inner cable creates a magnetic field circumferentially along the outer cable wires wound on the outer cylindrical surface of the inner cable. The outer cylindrical surface may be the inner cable itself, or may be a sheath or insulating layer that covers the inner cable. These longitudinal magnetic fields of the inner and outer cables make significant enhancements of the critical currents of the cables each other.

Throughout this disclosure, the term “double co-axial” refers to a superconducting power cable having an inner cable within an outer cable wound cylindrically around the inner cable. An object of the double co-axial cable of the present disclosure is to enhance a superconducting power cable performance using the longitudinal self-generated fields of the inner and outer cables.

One of the objects of the present disclosure to provide a high temperature superconductor compact power cable that can be used in power transmission applications. It is another object that these compact HTS DC and AC cables will carry significantly higher current than conventional HTS cables of ReBCO (such as YBCO, GdYBCO) BSCCO and MgB₂, and that the new cables may carry current in the 1,000-30,000 A range, but these cables are not limited to these values.

### BRIEF DESCRIPTION OF THE FIGURES

FIG. 1 is an illustration of a conceptual cable structure of the invention.

FIGS. 2(a)-2(b) illustrate the generated magnetic fields, where FIG. 2(a) illustrates the magnetic field generated by the inner cable current and FIG. 2(b) illustrates the magnetic field generated by the outer cable current.

FIG. 3(a) is an illustration of a first embodiment of the cable, comprising twisted stacked-tape cable (TSTC) and a winding flat cable.

FIG. 3(b) is an illustration of the twisted stacked-tape cable (TSTC) of FIG. 3(a),

FIG. 3(c) is an illustration of a winding flat tape cable of FIG. 3(a) on a round surface over the TSTC conductor.

FIG. 4(a) is an illustration of a second embodiment of the cable, comprising a multistage round wire cable and a winding flat tape cable.

FIG. 4(b) is an illustration of the multistage round wire cable of FIG. 4(a).

FIG. 4(c) is an illustration of the winding flat tape cable of FIG. 4(a) on a cylindrical surface over the inner conductor.

FIGS. 5(a)-5(c) show various inner cables, where FIG. 5(a) illustrates a multi-stage round wire cables such as NbTi, Nb3Sn, NbAl, MgB₂, and BSCCO-2212, FIG. 5(b) illustrates a twisted stacked-tape cabled conductor such as yttrium barium copper oxide (YBCO), Rare earth barium copper oxide (ReBCO), bismuth strontium calcium copper oxide (BSCCO), and magnesium diboride (MgB₂) and FIG. 5(c) illustrates a single stage round wire cable.

FIGS. 6(a)-6(d) illustrate other examples of the inner cable comprising multi-cables of Twisted Stacked-Tape cables (TSTC), where FIG. 6(a) shows two TSTC cables further twisted together, FIG. 6(b) shows three TSTC cables in a 3-channel helical groove copper rod, FIG. 6(c) shows a TSTC conductor composing one rectangular cross-section and two square cross-section which are together additionally twisted, and FIG. 6(d) shows a 3-stage 9-TSTC twisted-cable conductor.

FIG. 7(a)-7(b) shows typical outer cable examples, where FIG. 7(a) shows a winding flat tape cable such as MgB₂, YBCO, ReBCO and BSCCO, and FIG. 7(b) shows a single stage cable or a multi-stage cable of round wire cables, such as NbTi, Nb3Sn, NbAl, MgB₂, and BSCCO-2212.

FIG. 8 is an illustration of magnetic field around the outer cable. The outer cable current creates the axial field B_{OuterCable} parallel to the winding cylinder axis (z-axis). B_{InnerCable} shows the field due to the inner cable current which is tangential at any circumferential surface on the outer tape winding cylinder. The in-plane longitudinal component of B_{InnerCable} is the effective longitudinal field B_{L-OuterTape} which contributes to an enhancement of the outer wire performance.

FIGS. 9(a)-9(b) illustrate cable operation options of the inner and outer cables, where FIG. 9(a) shows anti-parallel current operation carrying equal and opposite currents, while FIG. 9(b) shows the same direction current carried by the inner and outer cables.

FIG. 10(a)-10(b) are illustrations of a reinforcement for a termination joint.

FIGS. 11(a)-11(b) show the inner conductor of stacked and twisted HTS tapes, where FIG. 11(a) is a Cross section, and FIG. 11(b) is a schematic illustration of a twisted stacked-tape conductor.

FIG. 12 shows an outer cable made of five helical winding cables, parallel windings on a cylindrical surface. One of the helical cables among the five is shown with a dark fill.

FIG. 13 is a table illustrating comparisons of existing HTS Tape cabling methods

### DETAILED DESCRIPTION

It was reported many years ago that, for strip samples of NbTi and Nb₃Sn, the critical current is highly dependent on the field direction. Especially if the in-plane magnetic field is parallel to the tape direction, i.e. the transport current direction (current direction), the critical currents were about a few times those in the transverse field. Since the electromagnetic force (Lorentz force) interaction between the field and the current can become weaker, the transport current is less disturbed by the magnetic field. This phenomenon is known as the “longitudinal” magnetic field effect.

As stated above, the longitudinal field effect has been observed for various low temperature superconductors, such as Nb₃Sn and NbTi, to enhance the current carrying capacities. Studies of field orientation effects for Nb₃Sn wires have shown that the critical currents have increased by a factor of two with the longitudinal field orientation.

This disclosure provides a new cable design to enhance a cable performance by using a coaxial cable structure comprising an inner cable and an outer cable. These inner and outer cables each produce a longitudinal magnetic field that affects the other cable. That is, the inner cable produces a longitudinal field to the outer cable and the outer cable produces a longitudinal field to the inner cable. These longitudinal magnetic fields mutually enhance the cable performance.

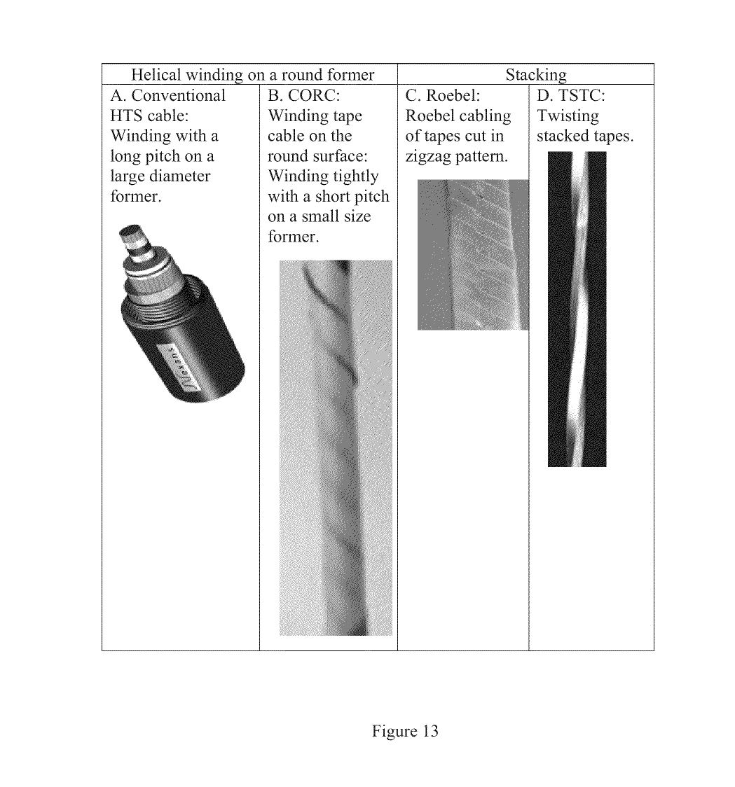

The self-generated magnetic field due to transport current of a tape or wire is mostly perpendicular to the tape surface. To obtain the longitudinal field in a superconducting cable, a special technique is needed. It has been disclosed that an advanced power cable structure using the longitudinal magnetic field effect may improve a HTS superconductor power cable transmission performance. However, this HTS cable is limited to the traditional power cable structure of the winding tape with long twist pitch, as shown in FIG. 13, column 1. Furthermore, the cabling requires a complicated tape arrangement to make the longitudinal field effective.

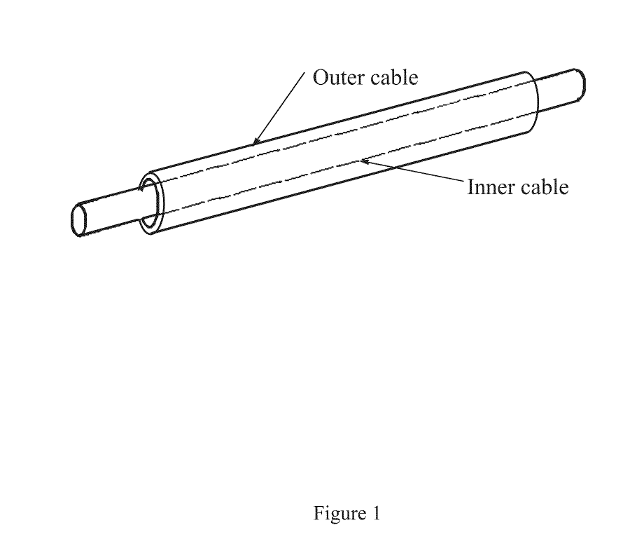

According to one embodiment, the power cable comprises an inner cable and an outer cable, which are two different types of cables structured co-axially, as shown in FIG. 1. Current through the inner cable creates a magnetic field circumferentially (along the wound outer cable wires) on the outer cylindrical surface of the inner cable. Current through the outer cable generates an axial field in the inner cable area of the outer cable wound cylindrically along the inner cable wires.

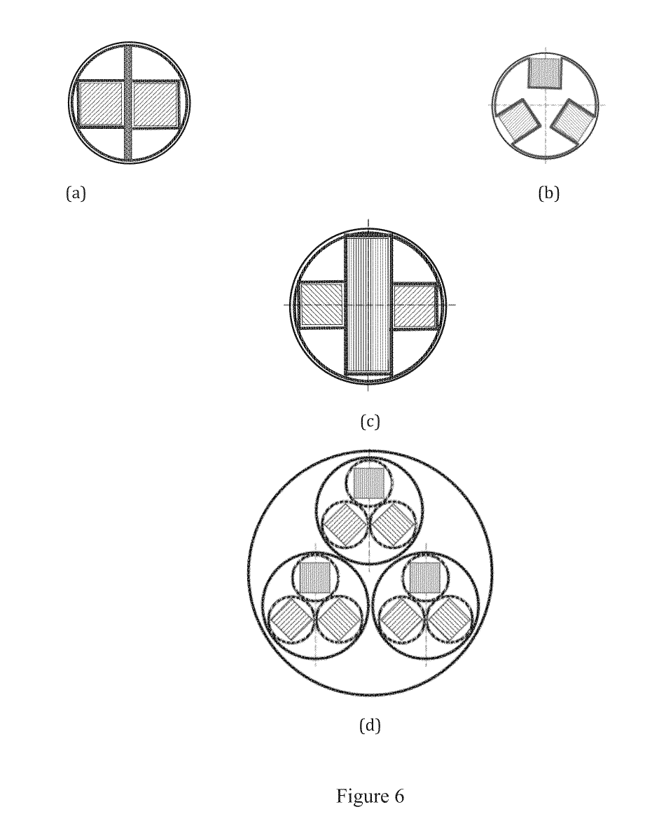

In some embodiments, the inner cable is encased in a cylindrical housing, and the outer cable is wound around the cylindrical housing. FIG. 6(a)-(d) show several embodiments of the inner cable where the inner cable is encased in a cylindrical housing.

For HTS tape applications, for example, a cable can comprise a twisted stacked-tape cable (see FIG. 13, column 4) for the inner cable and a winding tape cable on the round surface (see FIG. 13, column 2). The inner and outer cables are arranged co-axially, and the magnetic field produced by the inner cable currents creates the longitudinal field to the superconducting tapes of the outer cable, and the magnetic field produced by the outer cable currents creates the longitudinal field to the superconducting tapes of the inner cable. The longitudinal magnetic fields of these inner and outer cables make significant enhancements of the critical currents of the other cable.

This disclosure provides a high performance cable for power transmission applications using the magnetic fields induced by the transport currents. This is done by arranging two types of different structured cables co-axially, so that each cable creates mainly longitudinal (in-plane magnetic) fields to the wires of the other cable.

The disclosure is not limited to cables made of high temperature superconductors. Low temperature superconductors of tapes and round wires, such as NbTi, Nb₃Sn, and NbAl, as well as any other superconducting wires, such as MgB₂, may also be used. The longitudinal magnetic fields minimize the cable losses by reducing AC losses, and also the cryogenic losses by making a cable cross-sections compact.

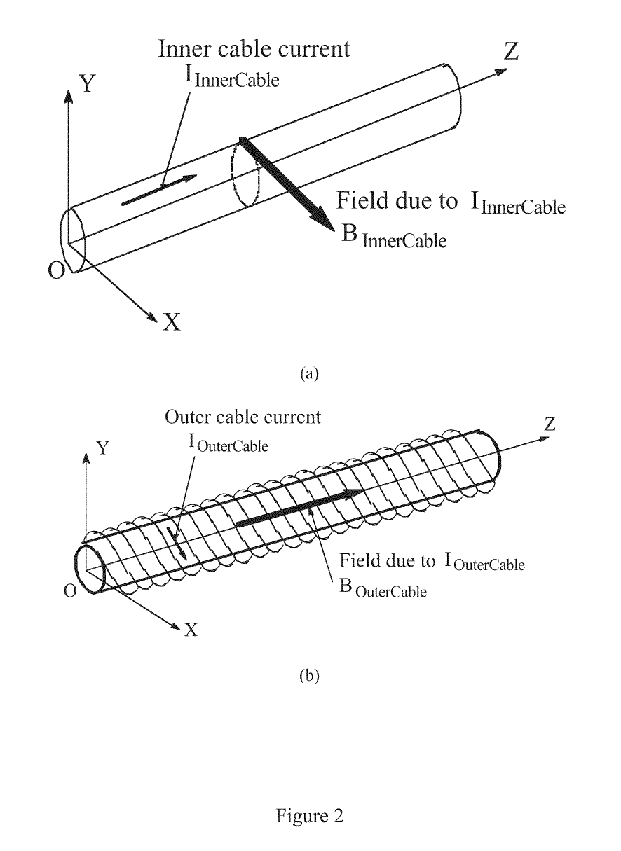

FIG. 2 illustrates magnetic fields due to two different conductors disposed in the inner and outer cables. FIG. 2(a) shows the magnetic fields generated by an inner cable substantially parallel to the z-axis, while FIG. 2(b) shows the magnetic fields generated by an outer cable wound on a cylindrical surface. A current of the straight cable on the z-axis creates magnetic fields B_{InnerCable} in the circumferential direction on the cylindrical surface along the cable (z-axis), as shown in FIG. 2(a). On the other hand, a current of the outer cable wound like a coil on the cylindrical surface along the z-axis is shown in FIG. 2(b). Therefore, the outer cable current generates a magnetic field B_{OuterCable} substantially parallel to the z-axis at the area inside of the outer cable.

The field B_{InnerCable}, due to the current of the inner cable, creates the (in-plane) longitudinal field to the wires of the outer cable, and B_{outerCable}, due to the current of the outer cable, creates the longitudinal field to the wires of the inner cable. The longitudinal fields enhance performance of the cable operation.

The magnetic field produced by the outer cable, B_{outerCable}, due to the current through the outer cable, is substantially parallel to the current through the inner cable. Additionally, the magnetic field produced by the inner cable, B_{InnerCable}, due to the current through the inner cable, is substantially parallel to the current through the outer cable. The deviation between the magnetic field, B_{InnerCable}, and the current of the outer cable is determined by the pitch of the outer cable, as described in more detail below. If the outer cable is comprised of multiple layers, the winding (twisting) direction may be selected to optimize the effective longitudinal field to the inner cable wires.

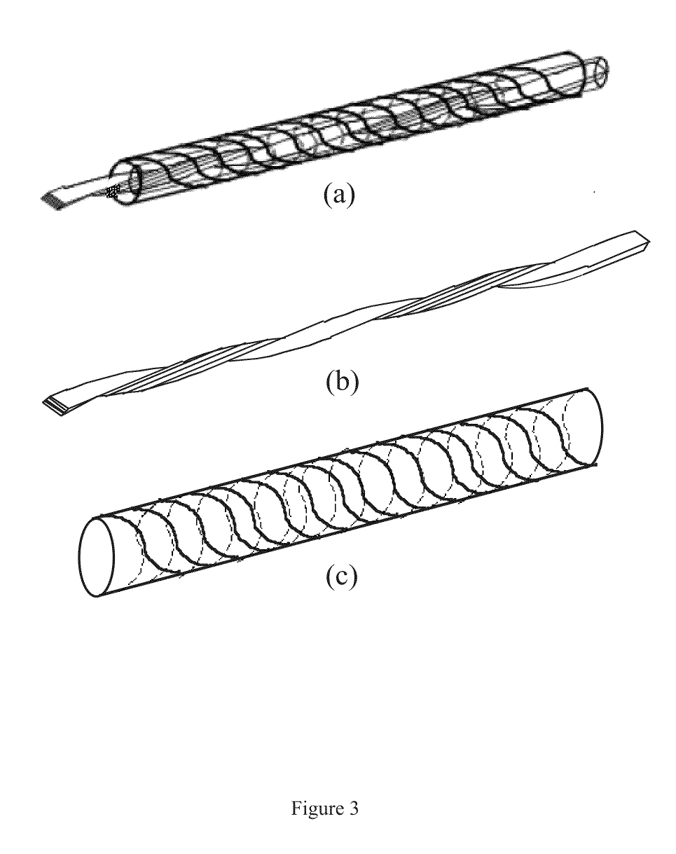

FIG. 3(a) illustrates a cable comprising an inner cable and an outer cable. The inner cable and outer cable are shown separately in FIGS. 3(b) and 3(c), respectively. For example, the inner cable may be a Twisted Stacked Tape Cable (TSTC), as shown in FIG. 13, column 4. The outer cable may be a winding flat tape cable on a round surface over the TSTC conductor. The outer winding tape cable on the round surface can be similar to a Conductor-on-Round-Core (CORC) shown in FIG. 13, column 2.

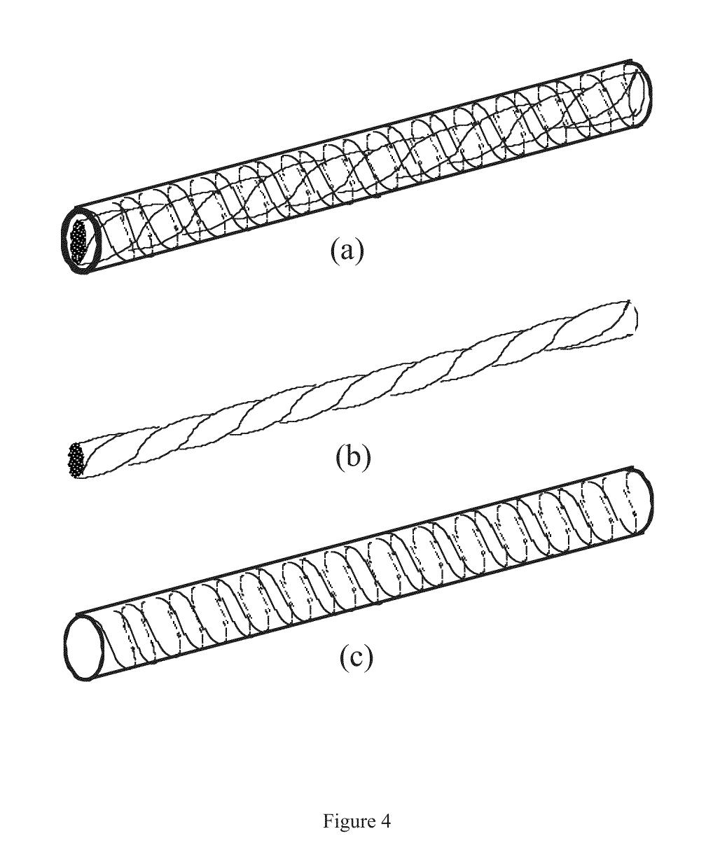

In FIG. 4(a), a second embodiment of the cable is illustrated, which comprises a multistage round wire cable and a winding flat tape cable on a cylindrical surface over the inner conductor. The multistage round wire cable and the winding flat tape cable are shown separately in FIGS. 4(b) and 4(c), respectively.

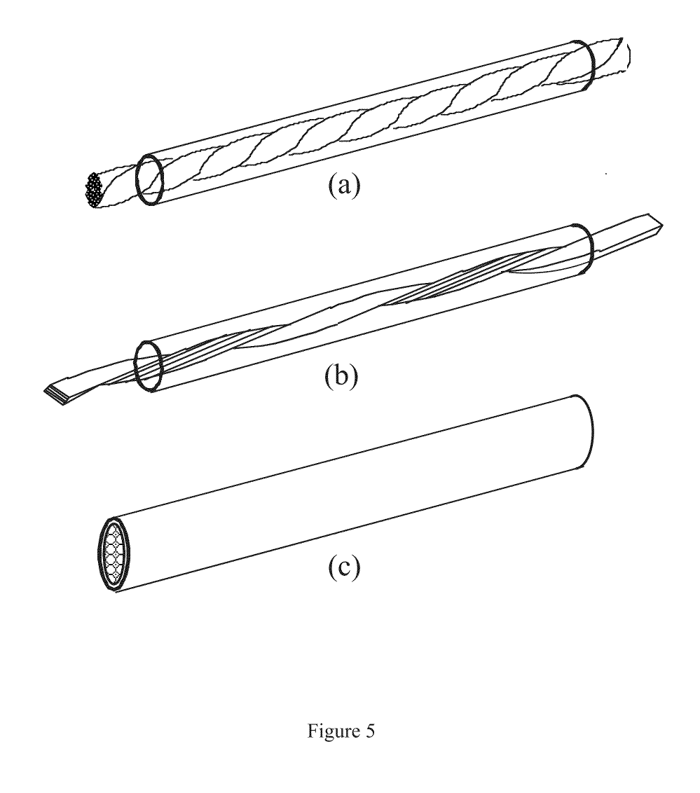

FIGS. 5(a)-5(c) shows various examples of inner cables. FIG. 5(a) shows multi-stage round wire cables such as NbTi, Nb3Sn, NbAl, MgB₂, and BSCCO-2212. FIG. 5(b) shows a twisted stacked-tape cabled conductor such as YBCO, ReBCO, BSCCO, and MgB₂ wires. Copper wires (tapes) also can be added in the stacked superconducting tapes. FIG. 5(c) shows a single stage round wire cable. These inner cables can be made of tape, round wire superconductors or a combination of the two.

FIGS. 6(a)-6(d) show examples of conductors comprising Twisted Stacked-Tape Cabling (TSTC), which can be used for the inner cable. FIG. 6(a) shows two TSTC cables further twisted together. FIG. 6(b) shows three TSTC cables in a 3-channel helical groove copper rod. FIG. 6(c) shows a TSTC conductor that is comprised of one rectangular cross-section TSTC and two square cross-section TSTC, which are together additionally twisted. FIG. 6(d) shows a 3-stage 9-TSTC twisted-cable conductor. Any of these conductors may be used for the inner cable.

The inner cable can be also used as a cable former which provides the cylindrical outer structure for the outer cable as described earlier. An electric insulation layer can be provided between the inner cable and outer cable if required. The previous examples show cables of multi-channel conductors for large capacity power cables. A cable-in conduit cable (CICC) type forced-flow conductors and Rutherford type cable also can be used for the inner cable.

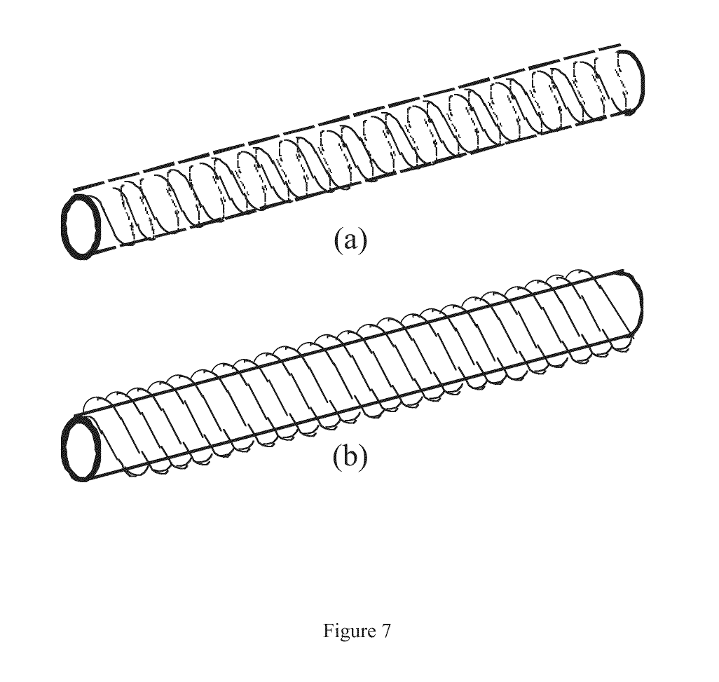

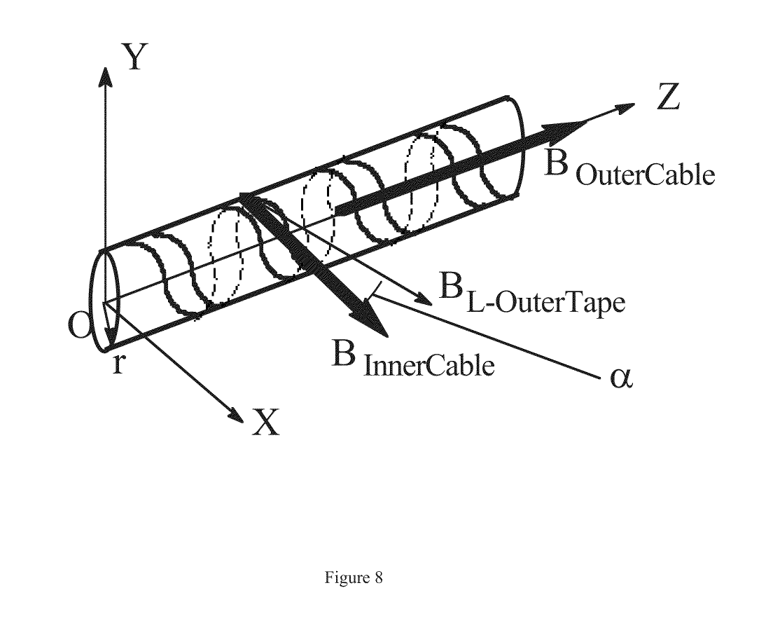

FIG. 7 shows two examples of outer cables. FIG. 7(a) shows a winding flat tape cable, such as MgB₂, YBCO, ReBCO and BSCCO. The tapes may be wound with multiple-helical-windings and multiple-layers. In other embodiments, a single winding flat tape cable is used. FIG. 7(b) shows a single stage cable or a multi-stage cable of round wire cables, such as NbTi, Nb₃Sn, NbAl, MgB₂, and BSCCO-2212. The cables also can be wound with multiple helical and multiple-layers. Alternatively, a single round wire cable may be used.

The inner and outer cables are not limited to those shown in FIGS. 5, 6 and 7. The inner cable is any cable of a relatively straight form. This inner cable can be any kind of superconducting wires, such as round wires and tapes. The outer cable needs to form a coil wound about the outside of the inner cable. Therefore, the superconducting wires of the outer cable should be bendable.

The current of each cable also creates a self-generated field relative to that cable. The actual magnetic field acting on each wire is a sum of its own self-generated field and the longitudinal field induced by the other cable mentioned above. In a case of the cable comprising flat tapes, current through the tape creates mainly a perpendicular field to the surface of the tape. With regards to the magnetic field components, the in-plane field is classified into two components: a transverse field, perpendicular to the transport current, and the longitudinal field, parallel to the transport current. For a cable of round wires, which comprise twisted-multifilament wires, the fields of a wire are classified as only two components: the transverse field perpendicular to the transport current and longitudinal field parallel to the transport current.

The outer cable current of a winding tape cable on the round surface creates a self-generated field B_{OuterCable} substantially parallel to the axis of the winding cylinder as shown in FIG. 8. This axial field B_{OuterCable} is substantially parallel to the inner cable direction. In some embodiments, this axial field B_{OuterCable} is parallel to the inner cable direction. The term “substantially parallel” denotes that the magnetic field is parallel to the overall direction of the inner cable. For example, the inner cable may be twisted, such that it is not completely straight. However, the overall direction of the inner cable may be along the Z-axis (see FIG. 8). Furthermore the outer cable is also twisted (wound) with a certain twist pitch, therefore the local outer magnetic field may not be straight and may not be exactly parallel along the inner cable axis. Thus, the magnetic field may be substantially parallel to the Z-axis, while not being exactly parallel to the current passing through inner cable at every position. Total fields of the B_{OuterCable} field and the self-generated fields of the inner cable wires contribute to enhance the critical current of the inner cable. These total fields may be optimized for the best result of the cable performance by selecting the twist pitch and twist direction of the inner cable as well as winding (twisting) pitch and direction of each layer of the outer cable.

On the other hand, the inner cable current creates the tangential field B_{InnerCable} on the circumference surface (the winding cylinder radius r) where the tapes of the outer cable are wound, as shown in FIG. 8. The inner field B_{InnerCable} is not exactly parallel to the longitudinal direction of the outer cable wires since the outer wires have a winding pitch Lₚ of a pitch angle α, here tan α=Lₚ/(2nr). Therefore the component, B_{InnerCable} cos α, of the field B_{InnerCable} is the effective longitudinal field B_{L-OuterTape} to the outer cable wires. More precisely speaking, total fields of the B_{InnerCable} field and the self-generated fields of the outer cable wires contribute to enhance the critical current of the outer cable. The total field may be optimized for the best result of the outer cable performance. Magnetic fields of the inner and outer cables will be discussed more in details later.

As an example of a HTS cable application, the superconducting cable may comprise an inner cable of a Twisted Stacked-Tape Cable and an outer cable of a winding tape (wire) cable on the round surface. This configuration makes possible a high performance superconducting cable by creating longitudinal magnetic fields parallel to the tape (wire) direction, i.e. the current direction. The HTS superconducting wires of the inner and outer cables may be ReBCO coated tapes such as YBCO and GdBCO tapes, and BSCCO tapes as well as MgB₂ tapes. The outer cable conductor is not limited to HTS tape conductors. Any kind of cables made of flat tapes (such as YBCO, BSCCO, MgB₂) and/or round wires (such as BSCCO, MgB₂, NbTi, Nb₃Sn, NbAl) can be used in order to enhance the inner cable performance. It is noted that MgB₂ and HTS wire cables are very useful for a cable of hydrogen temperature operation with liquid hydrogen coolant.

This double coaxial cable concept can be used for a cable having multiple stages. This multi-stage cable is made by twisting together a plurality of sub-cables. Each of these sub-cables can be made of a double coaxial cable comprising the inner and outer cables. A further higher multi-stage cable composing of the double coaxial cables can be made by twisting together a plurality of multi-stage cables to make a large twisted cable.

The double coaxial cable concept also can be used for an AC HTS superconducting cable. In an alternate method for an AC cable, the outer cable or a part of the outer cable-layers where the outer cable is made of two or more layers in the double co-axial cable can be used for a shield cable of an AC cable. Also, the inner cable can be used for the shield cable of an AC cable.

### Operational Modes of the Cable:

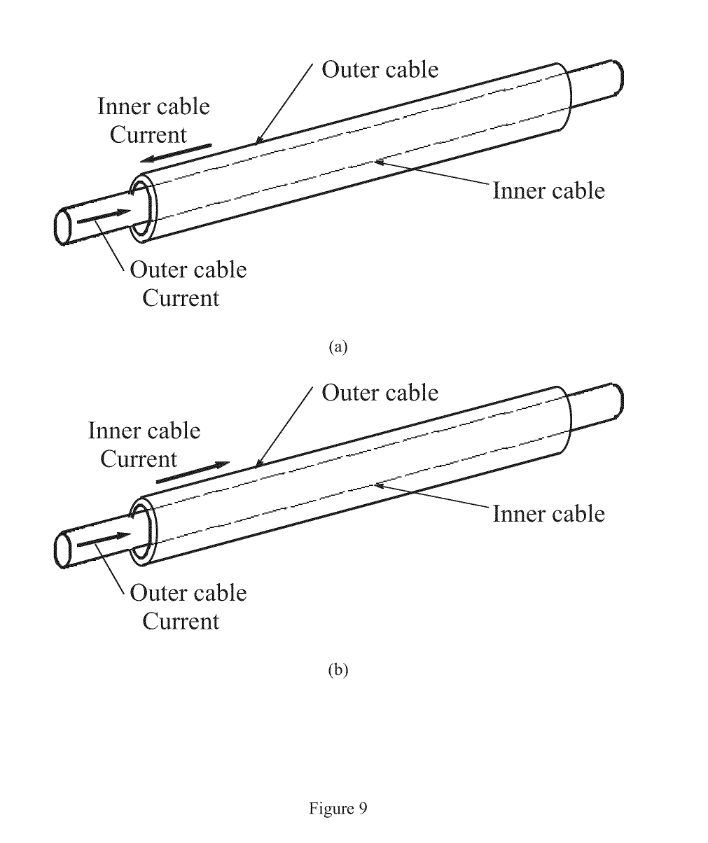

There are two operational modes of the cable for both DC and AC cables:
1. By using the inner and outer cables with an electrical insulating layer between them, the cable system can be used as a loop current supply as a full set of a power transmission line. That is, the inner and outer cables carry equal and opposite currents. This anti-parallel operation is shown in FIG. 9(a).
2. The inner and outer cables can carry the same direction currents. This embodiment is shown in FIG. 9(b). In this case, another set of the cable is used to transport a loop current in the opposite direction.

### Cable Termination Joint:

At the each end of the cable, i.e. at the cable termination, the longitudinal magnetic fields induced by the inner and outer cables may be smaller than that at the middle of the cables. For example, the axial longitudinal magnetic field induced by the outer cable of the winding tapes is known to become about half its strength at the edge. Therefore, the longitudinal magnetic fields are reduced at the cable ends, and consequently the performance enhancements due to the longitudinal field effect are reduced. To improve the cable performance at the edge sections, the cable ends are improved by:

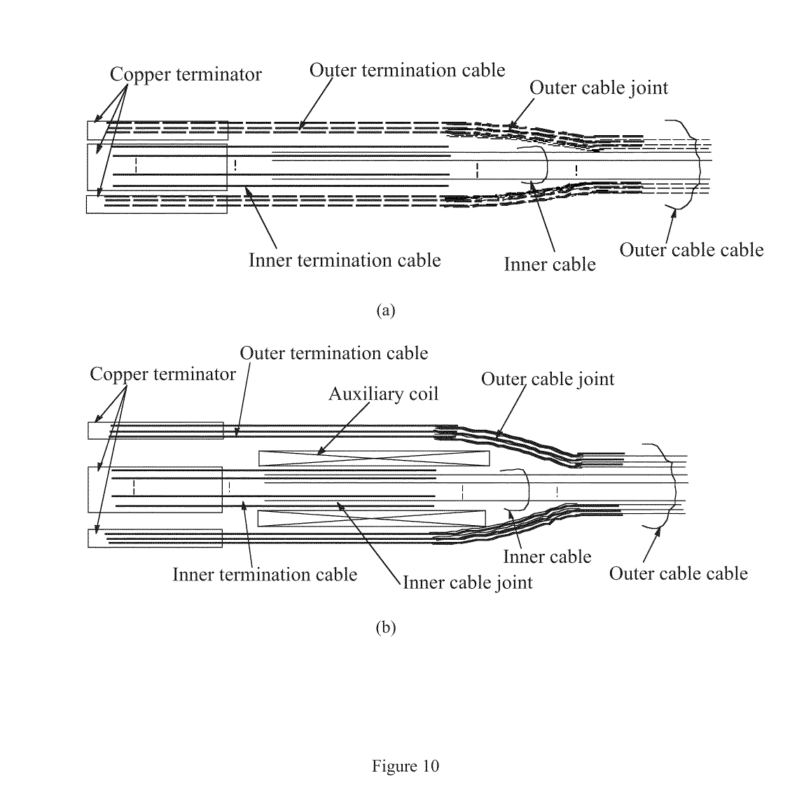

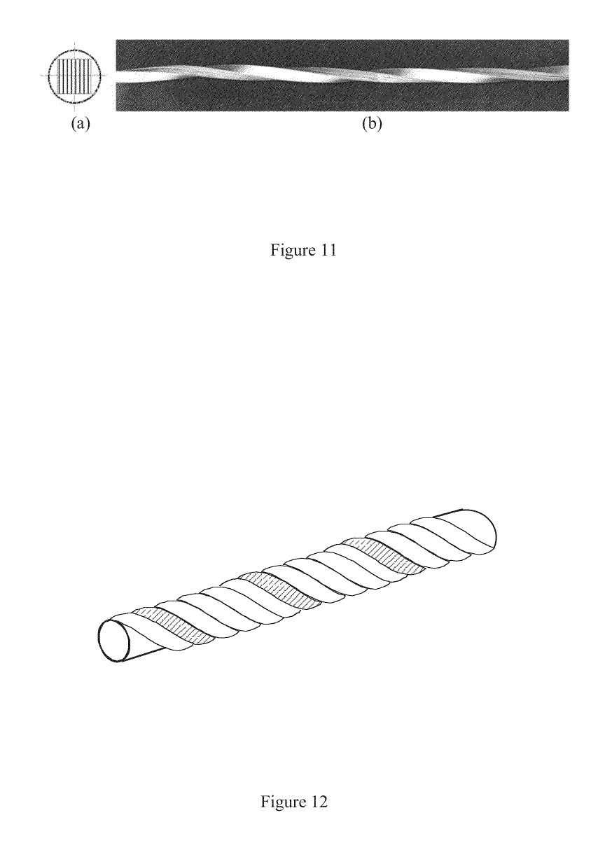

1. reinforcing the inner and outer cables at the edge (end) section with additional superconducting wires and/or copper wires disposed in parallel to the inner and outer superconducting wires of the cables at the ends. This is shown in FIG. 10(a).

2. adding additional coils to produce longitudinal magnetic fields to the inner cable in order to improve the longitudinal field effect if required. This is shown in FIG. 10(b).

3. reducing cable operation temperature at the cable end (termination area); for example, vapor pressure of coolant can be pumped down at the cable end section by a vacuum pump, so that the coolant temperature is reduced and safe operation of HTS tapes can be provided.

### Further Details of Inner and Outer Cables:

It is noted that if the outer cable comprises multiple layers, the effective field to the outermost layer of wires of the outer cable is produced additionally by the current flowing in the “inner” layers of wires of a part of the outer cable as well as by the current of the inner cable. If the outer cable carries a current of the same direction as that of the inner cable, the additional field due to the inner layer current increases the longitudinal field to the outermost layer tapes. On the other hand, if the inner cable carries an opposite current, the longitudinal field is decreased by the “inner” layer current. To improve the outer cable performance, the outermost layers of the outer cable can use superconducting wires having better critical currents such as wider tapes or larger diameter wires, and also winding directions of layers of the multiple-layer outer cables can be selected.

As discussed above, for the outer cable, the winding pitch angle α is given as a function of the winding pitch Lₚ and the winding radius by α=arctan (Lₚ/(2nr)). The effective longitudinal field for the outer cable is given with the winding angle α by B_{InnerCable} cos α, where B_{InnerCable} is the magnetic field generated by the inner cable, which is perpendicular to the cable axis. The winding pitch and winding radius of the outer cable may be optimized as well as the winding directions in order to obtain the most efficient longitudinal magnetic field effect on cable operation performance. If the winding twist pitch increases, the longitudinal field to the inner cable decreases given the same current of the outer cable. However, the wire length needed to make the outer cable can be reduced. Note that to make tighter winding (short twist pitch) the tape (wire) length becomes longer for making a given length cable. Therefore, optimization of the twist pitch should take into account the required longitudinal field strength for the inner cable, the operation current of the outer cable, and the winding diameter of the outer cable.

Any kind of superconducting conductors, such as round wire cables, tape cables, and flat cables of round wires, can be used for the outer cable. The outer cable can be made by winding (twisting) a wire or cable on the round surface. The twist-pitch may be between 0.1 to 50 times the wire-outer-dimension. The minimum twist pitch may typically be equal to the wire-outer-dimension. The wire-outer-dimension is related to the outer cable and is defined as a tape width for a tape conductor, or a wire diameter for a round wire conductor. If the outer cable is made of a sub-cable, the wire-outer-dimension is defined as the cable diameter of a round cable and the cable width for a flat cable such as Rutherford cable.

Selection of the winding (twisting) direction of the outer cable should be coordinated with the twisting direction of the inner cable and the current directions of the outer and inner cables in order to maximize the longitudinal magnetic fields to the wires (tapes). For example, a clockwise twisting direction for both the inner and outer cables may be used when the current directions of the outer and inner cables are the same. A counterclockwise direction may be used for one of these cables when the current directions are opposite one another. Selections of twisting directions of the inner cable and outer cable for the current directions are not limited to those mentioned above. That is, the clockwise and counterclockwise twisting directions may be used for both the inner and outer cables based on the desired current directions of the outer and inner cables and the configuration of each cable.

The outer cable winding for making the outer cable is not limited to a single helical winding. As shown in FIG. 12, the outer cable can be made of multiple helical windings (like the multiple helical threads for a screw). The number of helical winding is not limited and may be between 2 and 40. In this case, each cable of the helical windings carries a current in parallel.

The winding radius of the outer cable primarily depend on a diameter of the inner cable. Increases in winding radius result in increases in the wire length of the outer cable.

For the inner cable design, the twist-pitch length selection of the twisted stacked-tape cable is important to reduce AC losses and mechanical strain degradations. Furthermore, for the high performance cable, the twist-pitch length and its direction of the inner cable should be designed taking into account the total vector field summation of the magnetic fields induced by the outer cable current and the self-generated field of the inner cable.

The inner and outer cables can be operated at any temperature below the critical temperature of the superconducting wires, such as around 80 K to 4.2 K with using cryogenic coolants. These coolants may be gas and/or liquids of materials such as nitrogen, hydrogen and helium.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

What is claimed is:

1. A superconducting power cable, comprising:
an inner cable; and
a co-axial outer cable wound around a cylindrical outer surface of the inner cable;
wherein current through the outer cable produces an outer cable magnetic field substantially parallel to a direction of the inner cable.

2. The superconducting power cable of claim 1, wherein current through the inner cable produces an inner cable magnetic field substantially parallel to the current through the outer cable.

3. The superconducting power cable of claim 1, wherein the inner cable is made using Twisted Stacked-Tape cables made of HTS tapes.

4. The superconducting power cable of claim 1, wherein the inner cable comprising a plurality of Twisted Stacked-Tape cables.

5. The superconducting power cable of claim 4, wherein the plurality are twisted together.

6. The superconducting power cable of claim 1, wherein the inner cable is made from a material selected from the group consisting of round wires, tape conductors, cable-in conduit cable, and Rutherford type cables.

7. The superconducting power cable of claim 1, wherein at least one of the inner cable and the outer cable comprises tapes comprising a material selected from the group consisting of ReBCO, YBCO, GdBCO, BSCCO, and MgB₂.

8. The superconducting power cable of claim 1, wherein at least one of the inner cable and the outer cable comprises round wires comprising a material selected from the group consisting of BSCCO, MgB₂, NbTi, Nb₃Sn, and NbAl.

9. The superconducting power cable of claim 1, wherein the current in the inner cable travels in a direction opposite the current in the outer cable so that said power cable comprises a loop current supply.

10. The superconducting power cable of claim 1, wherein the current in the inner cable travels in the same direction as the current in the outer cable.

11. The superconducting power cable of claim 1, wherein the outer cable comprise multiple layers.

12. The superconducting power cable of claim 1, wherein a twist pitch of said outer cable is between 0.1 and 50 times an outer dimension of said outer cable.

13. The superconducting power cable of claim 11, wherein said twist pitch is determined based on a desired outer cable magnetic field.

14. The superconducting power cable of claim 1, wherein a twisting direction of each layer of said outer cable is determined based on the current direction in said inner cable and the current direction is said outer cable.

15. The superconducting power cable of claim 1, wherein said power cable is operated at a temperature below the critical temperature of the materials used to make said inner and outer cables.

16. The superconducting power cable of claim 1, wherein said cable has an end, and wherein additional conductors are disposed near said end to improve said outer cable magnetic field.

17. The superconducting power cable of claim 1, wherein said cable has an end, and wherein a vapor pressure of coolant supplied to said cable is lowered at said end, so as to lower an operating temperature at said end.

18. A superconducting power cable comprising:
a plurality of double coaxial cables twisted together;
wherein each of said double coaxial cables comprises:
an inner cable; and
a co-axial outer cable wound around a cylindrical outer surface of the inner cable;
wherein current through the outer cable produces an outer cable magnetic field substantially parallel to a direction of the inner cable.
